(19) United States
(12) Patent Application Publication
(10) Pub. No.: US 2010/0220579 A1
(43) Pub. Date: Sep. 2, 2010

(54) INFORMATION RECORDING DEVICE AND INFORMATION RECORDING PROGRAM

(75) Inventors: Naoharu Yanagawa, Saitama (JP); Akira Shirota, Saitama (JP)

Correspondence Address: DRINKER BIDDLE & REATH (DC), 1500 K STREET, N.W., SUITE 1100, WASHINGTON, DC, 20005-1209, US

(73) Assignee: PIONEER CORPORATION, Tokyo (JP)

(21) Appl. No.: 12/161,730

(22) PCT Filed: Jan. 19, 2007
(86) PCT No.: PCT/JP2007/050757

§ 371 Date: Jul. 22, 2008

(30) Foreign Application Priority Data
Jan. 24, 2006 (JP) 2006-015277

(51) Int. Cl. G11B 7/24

(52) U.S. Cl. 369/124.01; G9B/7.139

(57) ABSTRACT

It is an object to provide an information recording device capable of recording recording information with good recording property without wasting a recording region on an optical disk and capable of clearly forming visible portion. In a case where the visible portion is formed by using a recording pit supporting recording information Sr, the information recording device comprises an output unit 2 irradiating an optical beam B for forming a recording pit on an optical disk DK based on a driving signal Sp; a recording condition control unit 13 for generating the driving signal Sp; and a control signal generation unit 10 for controlling the recording condition control unit 13 to generate the driving signal Sp, while shifting a visible irradiation condition indicative of strength of the optical beam B and a wave shape of the driving signal Sp when forming a recording pit to be formed in the visible portion and an ordinal irradiation condition indicative of the strength of the optical beam B and the wave shape of the driving signal Sp when forming the recording pit other than the recording pit, based on any one of position and size of the visible portion on the optical disk DK.

### TECHNICAL FIELD

The present invention belongs to the field of an information recording device and an information recording program, particularly an information recording device that forms a visible portion visible from outside of a character, an image or the like by using a recording pit supporting recording information optically recorded and an information recording program thereof.

### BACKGROUND ART

Recently optical discs such as CD (Compact Disk) or DVD (Digital Versatile Disk) have been widely generalized as a recordable recording medium.

As an application example of information recording to the optical disk, a minute recording pit is formed on an information recording surface to record information and as exemplified by Patent Document 1 or 2, a human visible image or character is written on the information recording surface by using reflectance difference of visible light on the information recording surface. In such case, for example, if a name or the like of information recorded in an optical disk is written by using the visible information, it is advantageous that the trouble of separately attaching a label or the like on other side of the information recording surface is saved or that a title of information actually recorded on the optical disk and a title of information indicated on a label or the like are prevented from being incoherent.

Here, in the conventional art described in Patent Document 1 or 2 mentioned below, a portion other than the portion where a recording track is formed is devoted to recording the visible information, thereby adversely affecting a recording property (reproducing property) of information to be originally recorded by using recording pit or providing a region exclusively for visible information separately from a region for recording information. Therefore, there has been a problem that a recording capacity as optical disk itself may be reduced.

Therefore, in view of these problems, as described, for example, in Patent Document 3, a shape of the recording pit supporting information on the optical disk is caused to change between a region of recording visible information and the rest of the region so that a region where information to be originally recorded on the optical disk is recorded is overlapped with a region where visible information is recorded on the optical disk. Here, specifically, the shape change of the recording pit is realized by shifting strength of optical beam between a region for recording the visible information and the rest of the region:

[Patent Document 1] JP2005-92935

[Patent Document 1] JP2005-182859

[Patent Document 1] H6-36514 (FIG. 4)

### DISCLOSURE OF THE INVENTION

### Problems to be solved by the Invention

However, according to the art described in the above-mentioned Patent Document 3, because strength of an optical beam changes within a defined range where the recording pit corresponding to the information to be originally recorded can be formed, there has been a problem that original recording property may be adversely affected (i.e. the strength changing beyond the acceptable range of strength change of the optical beam for maintaining the recording property) in a case where the range is narrow due to recording property of the optical disk itself.

Further, there has been also a problem that reflectance cannot change enough to view as visible information, and as a result, visible information may not be written clearly enough to be visible.

Therefore, the present invention is provided in view of the above problems, and an example of the object of the present invention is to provide an information recording device capable of recording recording information in the recording medium with good recording property without wasting the recording region on the recording medium such as optical disk and capable of clearly forming even the visible portion on the recording medium, and an information recording program used for the information recording process thereof.

### Means for Solving the Problems

To solve above-mentioned problems, the present invention according to claim 1 is an information recording device that forms a visible portion visible from outside on a recording medium by using a recording pit supporting recording information optically recorded on the recording medium is provided with: an output device for irradiating an optical beam for forming the recording pit on the recording medium based on a driving signal; a driving device for generating the driving signal; and a control device for controlling the driving device to generate the driving signal, while shifting a visible irradiation condition that indicates strength of the optical beam and a wave shape of the driving signal when forming on the recording medium the visible recording pit being the recording pit to be formed in the visible portion and an ordinal irradiation condition indicative of the strength of the optical beam and the wave shape of the driving signal when forming the recording pit other than the visible recording pit on the recording medium being an ordinal irradiation condition different from the visible irradiation condition on the strength of the optical beam and the wave shape of the driving signal, based on visible portion information indicative of at least any one of position and size of the visible portion on the recording medium.

To solve above-mentioned problems, the present invention according to claim 10 is an information recording program that causes a computer included in an information recording device to function as a control device according to anyone of claims 1 to 8, the information recording device forming a visible portion visible from the outside on a recording medium by using a recording pit supporting recording information optically recorded on the recording medium, is provided with: an output device for irradiating an optical beam for forming the recording pit on the recording medium based on a driving signal; and a driving device for generating the driving signal.

### BRIEF DESCRIPTION OF THE DRAWINGS

FIG. 1 is a block diagram showing a schematic configuration of an information recording device related to a first embodiment.

FIG. 2 is a block diagram showing a detail configuration of the information recording device related to the first embodiment.

FIG. 3 is a flowchart (I) showing a recording process in the information recording device related to the first embodiment.

FIG. 4 is a flowchart (II) showing the recording process in the information recording device related to the first embodiment.

FIG. 5 is a diagram exemplifying a wave shape of a driving signal provided for the recording process in the information recording device related to the first embodiment.

FIG. 6 is a diagram exemplifying a recording power and a pulse width of an optical beam provided for the recording process in the information recording device related to the first embodiment. (a) is a diagram showing a relationship between the recording power and a jitter value, and (b) is a graph showing the change thereof.

FIG. 7 is a diagram showing a specific example of the optical disk where recording information is recorded and a visible portion is formed in the recording process in the information recording device related to the first embodiment.

FIG. 8 is a block diagram showing a detail configuration of an information recording device related to a second embodiment.

FIG. 9 is a flowchart showing a recording process in the information recording device related to the second embodiment.

FIG. 10 is a block diagram showing a schematic configuration of the information recording device related to a modified embodiment.

### DESCRIPTION OF REFERENCE NUMERALS

1 Driving unit;
2 Output unit;
3 Light-receiving unit;
4 Slider unit;
5 Reproduction property measurement unit;
6 Radial position detection unit;
7 Address information detection unit;
8 Angle information generation unit;
9 Memory;
10 Control signal generation unit;
11 Control position computing unit;
12 Recording power selection unit;
13, 20 Recording condition control unit;
14 Record data capacity confirmation unit;
15 System control unit;
13A Maximum recording power setting unit;
13B Minimum recording power setting unit;
13C, 20C Second strategy setting unit;
13D, 20D First strategy setting unit;
13E, 20E Switch;
20A First strategy recording power setting unit;
20B Second strategy recording power setting unit;
30 Address position calculation unit;
100, 200 Information recording device;
S0, S1, S2 Pulse;
A2 Visible portion;
A1, A3 Not-yet-record region;
B Optical beam;
DK Optical disk; and
PU Pickup

### BEST MODE FOR CARRYING OUT THE INVENTION

Next, embodiments of the present invention will be described with reference to drawings. Here, in the embodiments explained below, the present invention is applied to an information recording device that records information by forming recording pit on an optical disk as an optically information recordable recording medium and that forms a visible portion visible from outside (visible portion comprising of visible information) of the optical disk on an information recording surface of the optical disk.

### (I) First Embodiment

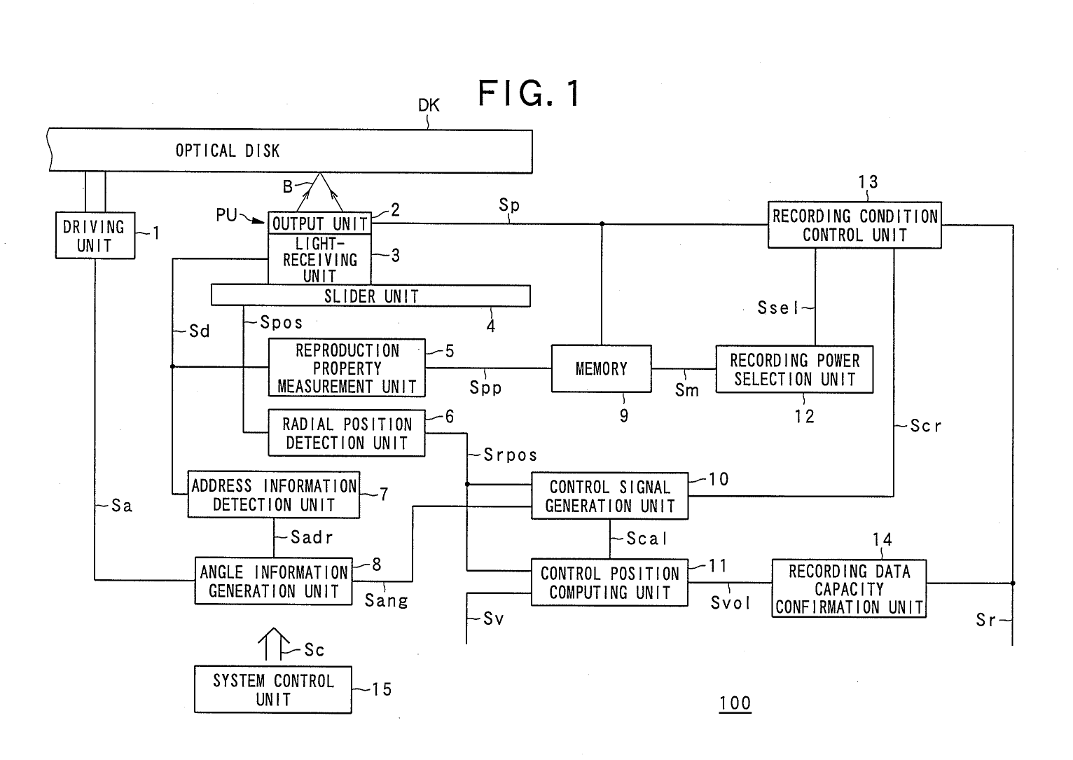

First, a first embodiment related to the present invention will be described with reference to FIGS. 1 to 6.

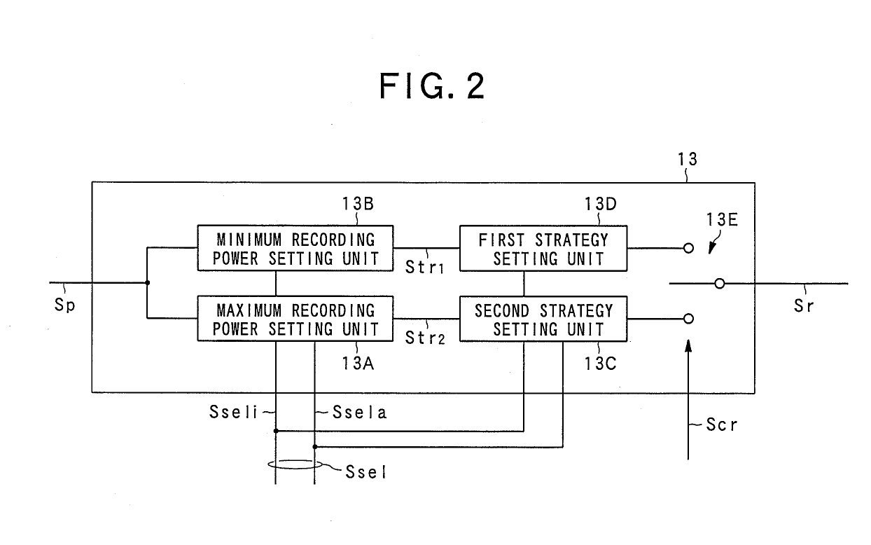

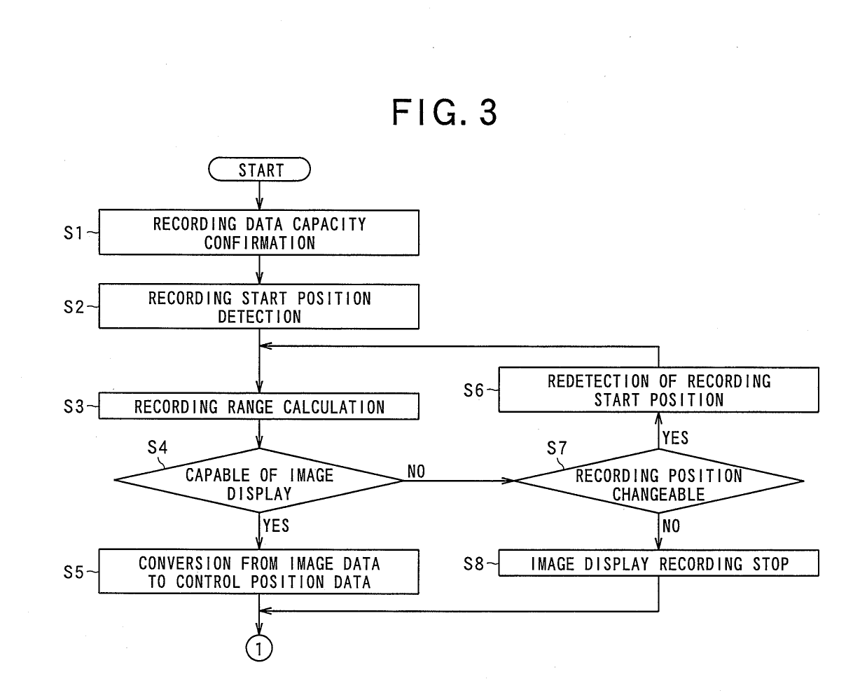

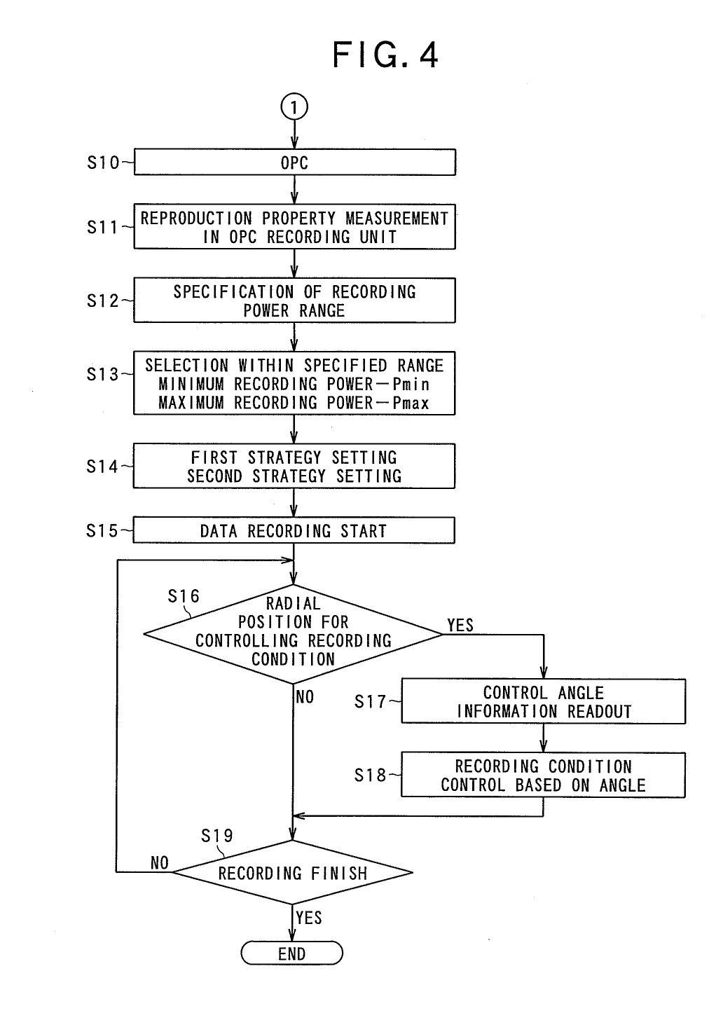

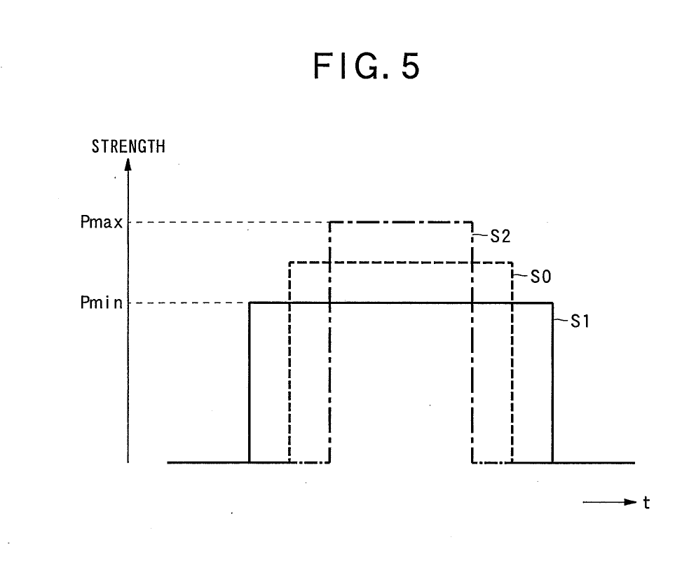

Here, FIG. 1 is a block diagram showing a schematic configuration of an information recording device related to a first embodiment. FIG. 2 is a block diagram showing a detail configuration of the information recording device. FIGS. 3 and 4 are flowcharts showing an action of the information recording device. FIGS. 5 to 7 are diagrams exemplifying effect of the information recording device.

As shown in FIG. 1, an information recording device 100 related to the first embodiment is configured by a driving unit 1 loaded with the above-mentioned recordable optical disk DK, a pickup PU including a light-receiving unit 3 and an output unit 2 as an output device, a slider unit 4, a reproduction property measurement unit 5, a radial position detection unit 6, an address information detection unit 7, an angle information generation unit 8, a memory 9, a control signal generation unit 10 as a control device, a control position computing unit 11, a recording power selection unit 12, a recording condition control unit 13 as a driving device, a record data capacity confirmation unit 14, and a system control unit 15.

Next, an overall action is described.

First, the driving unit 1 rotates the optical disk DK fixed to the driving unit 1 based on a control signal Sc from the system control unit 15, and generates rotation angle information Sa indicative of an optical disk rotation angle and outputs it to the angle information generation unit 8.

On the other hand, the output unit 2 formed of a semiconductor laser or the like irradiates an optical beam B having recording power (recording strength) indicated by a driving signal Sp (having a pulse wave shape as mentioned later) from the recording condition control unit 13 to an information recording surface of the optical disk DK, and forms the recording pit.

The light-receiving unit 3 formed of an optical detector and the like receives reflected light from the information recording surface of the optical beam B, generates a receiving signal Sd corresponding to the strength of the reflected light thus received and outputs it to the reproduction property measurement unit 5 and the address information detection unit 7.

Here, the pickup UP itself moves in a radial direction of the optical disk DK due to an action of the slider unit 4 based on a control signal Sc from the system control unit 15. This time, the slider unit 4 generates a position signal Spos which is used when detecting a radial position of the optical disk DK of the pickup PU, and outputs it to the radial position detection unit 6.

The radial position detection unit 6 generates radial position information Srpos indicative of a radial position of the optical disk DK of the pickup PU based on the position signal Spos, and outputs it to the control signal generation unit 10 and the control position computing unit 11.

On the other hand, the address information detection unit inputted with the light-receiving signal Sd detects preaddress of the optical disk DK currently irradiated with an optical beam B, based on the light-receiving signal Sd, generates a preaddress information Sadr indicative of thus detected position and outputs it to the angle information generation unit 8.

Accordingly, the angle information generation unit 8 generates angle information Sang indicative of an angle from a reference position preset on the optical disk DK (angle centered on a center of optical disk DK) in the position on the optical disk DK currently irradiated with the optical beam B, based on the preaddress information Sadr and the angle information Sa and outputs it to the control signal generation unit 10.

The control signal generation unit 10 always recognizes an irradiation position of the optical beam B on the optical disk DK together with a radial position of the optical disk DK of the pickup PU itself, based on the angle information Sang and the radial position information Srpos. Thereby, the control signal generation unit 10 generates a recording condition control signal Scr indicative of timing of changing an amplitude and a pulse wave shape of the driving signal Sp, based on a later-described control position information Scal outputted from the control position computing unit 11 and thus recognized irradiation position of the optical beam B, and outputs it to the recording condition control unit 13.

Next, the reproduction property measurement unit 5 detects a reproduction property of OPC information recorded on the optical disk DK during an OPC operation, based on the light-receiving signal Sd outputted during the action of OPC (Optical Power Control) carried out before visible information is actually written and information is actually recorded (i.e. recording pit related to the present invention being formed), and outputs it to the memory 9 as the reproduction property signal Spp.

Here, the OPC operation is an action of previous test writing carried out to the optical disk DK for setting a recording power and a pulse width (i.e. a recording power corresponding to amplitude of the driving signal Sp and a pulse width corresponding to pulse width of the driving signal Sp) of the optical beam B used for the above-mentioned actual writing, and an action where thus preset OPC information is actually recorded on the optical disk DK, and subsequently the OPC information is detected and reproduced, thereby evaluating the recording power, the pulse width, or the like of the optical beam B at the time of recording the OPC information.

Accordingly, the memory 9 makes the amplitude and the pulse width of the driving signal Sp outputted from the recording condition control unit 13 during the OPC operation correspondent to a content of the reproduction property signal Spp corresponding thereto, and readably memorizes an evaluation list associated with the recording power and the pulse width of the optical beam B.

The recording power selection unit 12 reads out the evaluation list memorized in the memory 9 as memory information Sm when necessary, refers to a preset criterion for the reproduction property (more specifically e.g. jitter amount included during reproduction of the OPC information) of the OPC information, selects a minimum recording power and a maximum recording power within a range where it is judged good, and outputs them to the recording condition control unit 13 as power selection information Ssel.

Here the power selection information Ssel includes minimum power selection information Sseli indicative of the minimum recording power and maximum power selection information Ssela indicative of the maximum recording power. Further, the minimum power selection information Sseli also includes information indicative of a pulse width of the driving signal Sp (i.e. pulse width of optical beam B) to be changed in response to the minimum recording power as well as information indicative of the minimum recording power. Further, the maximum power selection information Ssela also includes information indicative of a pulse width of the driving signal Sp to be changed in response to the maximum recording power as well as information indicative of the maximum recording power.

Here, with respect to a pulse of the driving signal Sp to be changed in response to the maximum recording power and the minimum recording power respectively, for example, in a case where the optical disk DK is a DVD, any one of a pulse width corresponding to the minimum recording pit and both pulse widths corresponding to the minimum recording pit and the second minimum recording pit respectively is satisfied.

Accordingly, the recording condition control unit 13, during the above-mentioned actual recording pit formation, carries out a modulation process or the like to the recording information Sr forming recording pit to record on the optical disk DK, in order to output the optical beam B by using any one of the recording power and pulse width among two types of recording power and pulse selected by the power selection information Ssel during the OPC operation, generates the driving signal Sp and outputs it to only the output unit 2 in the pickup PU.

Here, selection of the recording power and the pulse width at the time of forming the recording pit is carried out by time indicated by the recording condition control signal Scr outputted from the control signal generation unit 10.

Further in the OPC operation, the recording condition control unit 13 generates the driving signal Sp indicating the strength of the optical beam B to be gradually changed during the OPC operation regardless of recording information Sr to be actually recorded, and outputs it to the output unit 2 and the memory 9.

On the other hand, the recording data capacity confirmation unit 14 confirms information volume of the entire recording information Sr to be actually recorded on the optical disk DK, and outputs confirmation information Svol indicating the information volume to the control position computing unit 11.

Accordingly, based on the radial position information Srpos, a display image information Sv that is information of an image or the like to be recorded with the recording information Sr as visible information on the optical disk DK, and the confirmation information Svol, the control position computing unit 11 specifies a region (portion) on the optical disk DK to form the visible information, generates the control position information Scal indicating a position (a radial position of the optical disk DK and a position indicated by an angle from the reference position) on the optical disk DK shifting the recording power and the pulse width of the optical beam B to form the visible information, and outputs it to the control signal generation unit 10 to provide for writing the visible information and recording the recording information Sr.

In parallel with this, the system control unit 15 generates the control signal Sc for integrated control to respective construction elements to integrally control operations of the above construction elements, and outputs respectively. Further, overall action state of the information recording device 100 is displayed in a display unit not shown. Further, an operation to instruct actions for carrying out in the information recording device 100 is carried out in an operation unit not shown. The system control unit 15 carries out the integrated control based on the operation.

Next, detail configuration of the recording condition control unit 13 related to the present invention is described with reference to FIG. 2.

As shown in FIG. 2, a recording condition control unit 13 related to the first embodiment is configured by a maximum recording power setting unit 13A, a minimum recording power setting unit 13B, a second strategy setting unit 13C, a first strategy setting unit 13D, and a switch 13E.

In such the configuration, the minimum recording power of the optical beam B indicated by the minimum power selection information Sseli outputted from the recording power selection unit 12 is memorized in the minimum recording power setting unit 13B, and information indicating pulse width of the driving signal Sp indicated by the minimum power selection information Sseli is memorized in the first strategy setting unit 13D.

Further, the maximum recording power of the optical beam B indicated by the maximum power selection information Ssela outputted from the recording power selection unit 12 is memorized in the maximum recording power setting unit 13A, and information indicating pulse width of the driving signal Sp indicated by the maximum power selection information Ssela is memorized in the second strategy setting unit 13C.

On the other hand, the switch 13E shifts output destination of the recording information Sr based on the recording condition control signal Scr outputted from the control signal generation unit 10, and outputs it to any one of the first strategy setting unit 13D or the second strategy setting unit 13C.

Specifically as timing of the shift, it is desirable to shift during a period when the recording pit supporting it is not formed in the recording process of recording information Sr described later.

When the recording information Sr is outputted to the first strategy setting unit 13D through the switch 13E, the first strategy setting unit 13D generates the strategy signal Str1 having a pulse wave shape for driving the output unit 2 to cope with the recording information Sr. At this time, a pulse width of the strategy signal Str1 is set so as to correspond to the pulse width of the driving signal Sp memorized in the first strategy setting unit 13D at that time.

Accordingly, the minimum recording power setting unit 13B changes an amplitude in the strategy signal Str1 outputted from the first strategy setting unit 13D to an amplitude corresponding to the recording power memorized in the minimum recording power setting unit 13B at that time, generates the driving signal Sp having an amplitude corresponding to the recording power indicated by the minimum power selection information Sseli, and outputs it to the output unit 2.

On the other hand, when the recording information Sr is outputted to the second strategy setting unit 13C through the switch 13E, the second strategy setting unit 13C generates the strategy signal Str2 having a pulse wave shape for driving the output unit 2 to cope with the recording information Sr. At this time, a pulse width of the strategy signal Str2 is set so as to correspond to the pulse width of the driving signal Sp memorized in the second strategy setting unit 13C at that time.

Accordingly, the maximum recording power setting unit 13A changes an amplitude in the strategy signal Str2 outputted from the second strategy setting unit 13C to an amplitude corresponding to the recording power memorized in the maximum recording power setting unit 13A at that time, generates the driving signal Sp having an amplitude corresponding to the recording power indicated by the maximum power selection information Ssela, and outputs it to the output unit 2.

Next, a visible information recording process and a recording information Sr recording process related to the present invention, that are carried out in the information recording device 100 having the above-mentioned configuration, will be described specifically with reference to FIGS. 3 to 5.

In the process of recording each of information related to the present invention, first a range where a visible portion corresponding to visible information is formed on the information recording surface of the optical disk DK is specified.

In other words, as shown in FIG. 3, when recording visible information corresponding to recording information Sr starts, first the recording data capacity confirmation unit 14 confirms information volume of entire recording information Sr to be recorded on the optical disk DK (Step S1), and detects a recording start position of the recording information Sr on the optical disk DK that is set by, for example, a user, on the optical disk DK based on a light-receiving signal Sd (Step S2).

A region where the recording information Sr is recorded on the optical disk DK is calculated based on the recording start position and the information volume respectively detected (Step S3).

Next, it is confirmed whether or not the visible information (visible portion) corresponding to the image information Sv is fit in the region, in other words, an area of the region is larger than an area of the visible portion (Step S4). When the area of the region is larger than the area of the visible portion (Step S4: YES), it is considered possible that the recording pit supporting the recording information Sr on the optical disk DK forms the visible portion corresponding to the image information Sv. The control position computing unit 11 generates the control position information Scal corresponding to the image information Sv (Step S5), and the process goes to the recording information Sr recording process described later.

On the other hand, in the judgment of Step S4, when the area of the region where the recording information Sr is recorded is smaller than the area of the visible portion (Step S4: NO), it is considered impossible that the recording pit supporting the recording information Sr on the optical disk DK forms the visible portion corresponding to the image information Sv. Therefore, next, it is confirmed whether or not the recording position on the optical disk DK of the recording information Sr is changeable on the optical disk DK based on information volume or the like of entire recording information Sr (Step S7). When it is changeable (Step S7: YES), a recording start position of the recording information Sr is detected again (Step S6), and the process returns to the Step S3 to repeat the processes for new recording start position.

On the other hand, in the judgment of Step S7, in a case where the recording position on the optical disk DK of the recording information Sr is not changeable (Step S7: NO), it is no longer possible to form the visible region for the recording information Sr recording process. Therefore, the effect is displayed in the display unit not shown or the like to notify the user (Step S8), and the procedure goes to the process described later shown in FIG. 4 to carry out a recording process only for the recording information Sr subsequently.

Next, an actual recording process carried out after specifying the region of forming the visible portion as shown in FIG. 3 is described.

As shown in FIG. 4, in the recording process, first the OPC operation is carried out to the optical disk DK provided for the actual recording process by a similar process to the conventional one (Step S10). The reproduction property of the OPC information used in the OPC operation is confirmed in the reproduction property measurement unit 5 by detecting a jitter amount included in the signal reproducing the OPC information or the like (Step S11). A range of the recording power of the optical beam B, where the reproduction property in the preset acceptable range can be obtained, is specified (Step S12).

Next, the maximum recording power within the range specified in the process of Step S12 is set as the maximum recording power of the optical beam B related to the first embodiment, the minimum recording power within the range is further selected as the minimum recording power of the optical beam B related to the first embodiment (Step S13). The power selection information Ssel indicating the respective powers is generated and outputted to the recording condition control unit 13.

Next, based on a degree of pulse width change preset to cope with the selected respective recording powers, the pulse width (referred to as “first strategy” in FIG. 4) of the driving signal Sp corresponding to the minimum recording power and the pulse width (referred to as “second strategy” in FIG. 4) of the driving signal Sp corresponding to the maximum recording power are respectively set, and the power selection information Ssel respectively indicative of thus set pulse width is generated and outputted to the recording condition control unit 13 (Step S14).

With the above operation, setting the recording power and the pulse width for carrying out together the recording information Sr recording process and forming the visible portion corresponding to the visible information finishes. Here it is arbitrarily selectable during manufacturing in the information recording device 100 whether the optical beam B for forming the visible portion is set to the minimum recording power and the pulse width corresponding thereto (in this case, the optical beam B for forming the portion other than the visible portion being set to the maximum recording power and the pulse width corresponding thereto) or the optical beam B for forming the visible portion is set to the maximum recording power and the pulse width corresponding thereto (in this case, the optical beam B for forming the portion other than the visible portion being set to the minimum recording power and the pulse width corresponding thereto).

Here, as specific examples of the maximum recording power and the pulse width corresponding thereto, and the minimum recording power and the pulse width corresponding thereto, for example as shown in FIG. 5, it is desirable to set in such manner that a pulse width of the minimum pulse S2 (indicated by a chain line in FIG. 5) of the driving signal Sp corresponding to the maximum recording power Pmax is smaller than a pulse width of pulse S0 (indicated by a broken line in FIG. 5) of the driving signal corresponding to the driving signal Sp in the conventional art. Further, it is desirable to set in such manner that a pulse width of the minimum pulse S1 (indicated by a solid line in FIG. 5) of the driving signal Sp corresponding to the minimum recording power Pmin is larger than a pulse width of pulse S0 of the driving signal in the conventional art.

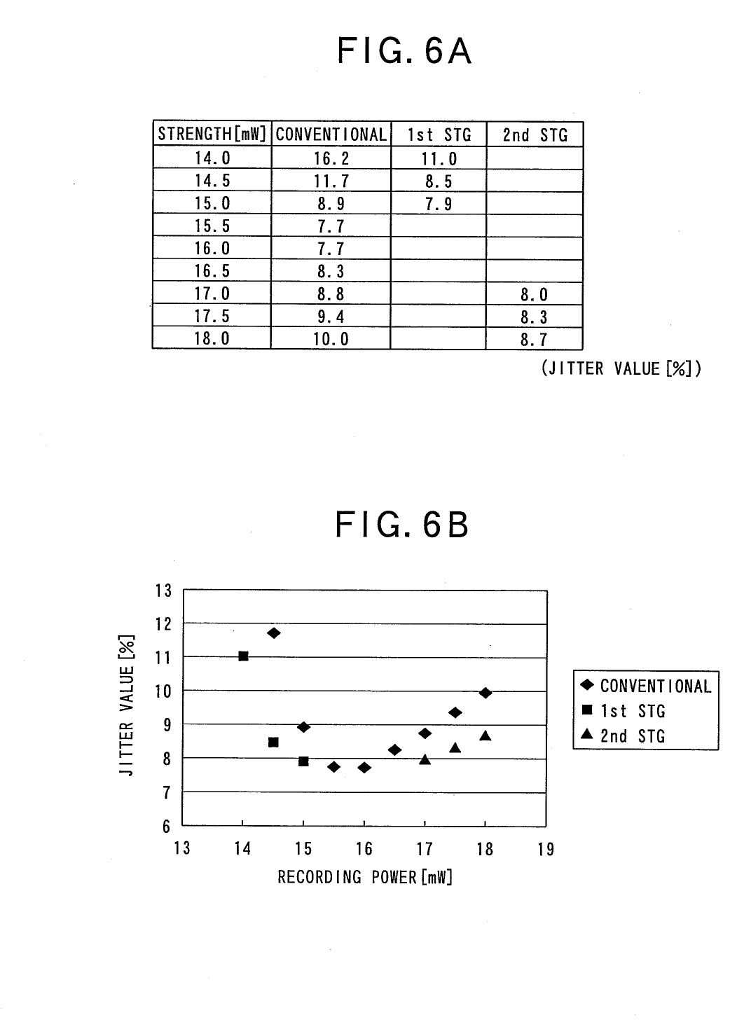

As more specific example, for example, in a case where a relationship between a strength and a jitter value as exemplified in FIG. 6(a) is obtained in the conventional art shown in Patent Document 3, reproduction property can be improved (reduction of the jitter value) by changing the pulse width in response to the recording power as shown in FIG. 5. In a case where an acceptable range as reproduction property is preset to 9% or less in terms of jitter value, 18.0 mW is used as a maximum recording power value according to the first embodiment, and 14.5 mW is used (difference of 3.5 mW) as a minimum recording power value. Here, the bigger difference between the maximum recording power value and the minimum recording power value is, the more clearly the visible portion as the visible information can be formed in contrast with the other portion. Therefore, it is possible to more clearly record the visible information together with recording information Sr, maintaining the preset recording property (reproduction property) at the same time, compared with the conventional art (in the example shown in FIG. 6, 17.0 mW is employed as the maximum recording power value and 15.0 mW is employed as the minimum recording power value (difference of only 2.0 mW)).

Here, according to the experiment by the present inventors, as shown in FIG. 6(b), it is found that the pulse width related to the first embodiment (in FIG. 6(b), the pulse width corresponding to the minimum recording power is indicated as “1st STG”, and the pulse width corresponding to the maximum recording power is indicated as “2nd STG”) is employed, thereby improving the recording property (reproduction property) as shown in FIG. 6(b).

Although in the example shown in FIG. 5, the case where the pulse width of the minimum pulse of the driving signal Sp changes is changed based on the present invention is explained, it is not limited thereto. In addition to the minimum pulse or instead of the minimum pulse, the pulse width of the pulse larger than the minimum pulse may be changed based on the present invention.

According to the operations in Steps S10 to S14, after the maximum recording power and the pulse width, and the minimum recording power and the pulse width related to the first embodiment are set, input of the recording information Sr into the information recording device 100 starts (Step S15) and the recording information Sr recording process starts. Here, the recording power and the pulse width of the optical beam B are the maximum recording power and the pulse width corresponding thereto or the minimum recording power and the pulse width corresponding thereto.

During the recording information Sr recording process, it is monitored whether or not the irradiation position of the optical beam B reaches the radial position to shift the recording power and the pulse width of the optical beam B obtained in Step S5 (Step S16). When the irradiation position does not reach the radial position to shift the recording power and the pulse width yet (Step S16: NO), it is monitored whether or not recording all of the recording information Sr to be recorded is completed, while continuing the recording information Sr recording process (Step S19). Upon the completion of the recording process (Step S19: YES), all the recording process related to the first embodiment is finished. When all the recording information Sr is not recorded yet (Step S19: NO), the process returns to Step S16 to continue the recording information Sr recording process.

On the other hand, in the judgment of Step S16, when the irradiation position reaches the radial position for shifting the recording power and the pulse width corresponding thereto (Step S16: YES), the angle information corresponding to the radial position is confirmed by the control position information Scal from the control position computing unit 11 (Step S17). The angle shifting the recording power and the pulse width corresponding thereto is shifted while comparing the angle position corresponding to the current irradiation position (Step S18). The process goes to the Step S19 to continue recording the recording information Sr, and the process related to Step S16 through the Step S19 is repeated until recording is finished (Step S19: YES). Here, in the repeated process, recording conditions may be changed in plural times (usually even number times) based on the change of angle in some cases, even it is the same radial position.

Thus explained, according to the operation of the information recording device 100 related to the first embodiment, the irradiated optical beam B is set in such manner that the recording power of the optical beam B and the wave shape of the driving signal Sp are different between the case where the recording pit corresponding to the visible portion is formed on the optical disk DK and the case where the recording pit corresponding to the portion other than the visible portion is formed on the optical disk DK. The visible portion is formed by using the recording pit for recording the recording information Sr while combining formation of the visible portion and maintenance of the recording property (reproduction property) of the recording information Sr. Therefore, it is possible to record the recording information Sr with good recording property without wasting the recording region on the optical disk DK and clearly form the visible portion.

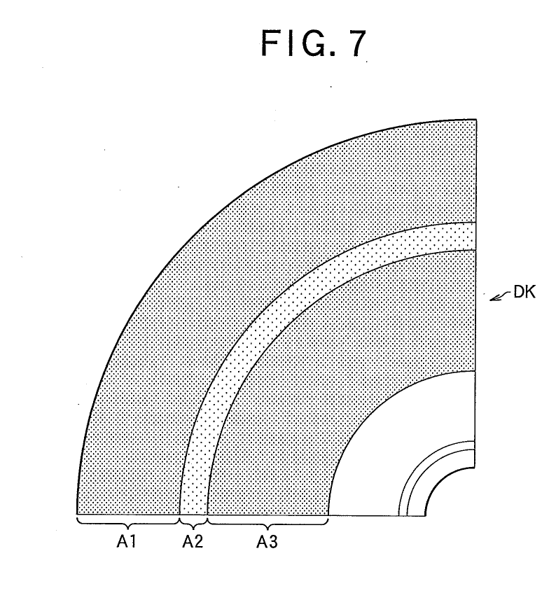

The example of using the information recording device 100 related to the first embodiment is shown in FIG. 7. In a portion A2 where the recording information Sr is recorded in FIG. 7, it is clearly visible that the visible portion recorded together with the recording information Sr and the already-recorded portion where only the rest of recording information Sr is recorded are formed alternately twice.

Further, the condition is shifted during the period the recording pit is not formed in recording of the recording information Sr. Therefore, it is possible to prevent deterioration of the recording property of the recording information Sr because the recording pit is formed while the conditions are being shifted and moved.

Further, between the pulse wave shape of the driving signal Sr corresponding to the visible portion and the pulse wave shape of the driving signal Sp corresponding to the rest of the portion, the pulse width is different in response to the difference between the recording power of the optical beam B corresponding to the visible portion and the recording power of the optical beam B corresponding to the rest of the visible portion. Therefore, it is possible to form the visible portion by using the recording pit while maintaining the good recording property of the recording information Sr at the same time.

Further, the respective pulse wave shape as a condition is the pulse wave shape corresponding to at least the minimum recording pit. Therefore, it is possible to effectively change the mode of the recording pit to form the visible portion.

Further, in a case where the strength of the recording power of the optical beam B corresponding to the visible portion is higher than the conventional optimal strength, and the strength of the recording power of the optical beam B corresponding to the rest of the visible portion is lower than the optimal strength, it is possible to form the visible portion more clearly than visual in contrast with the rest of the visible portion.

Further, in a case where the strength of the recording power of the optical beam B corresponding to the visible portion is higher than the conventional optimal strength, the strength of the recording power of the optical beam B corresponding to the rest of the visible portion is lower than the optimal strength, the pulse width of the optical beam B corresponding to the visible portion is smaller than the conventional one, and the pulse width of the optical beam B corresponding to the rest of the visible portion is larger than the conventional one, or in a case where the strength of the recording power of the optical beam B corresponding to the visible portion is lower than the conventional optimal strength, the strength of the recording power of the optical beam B corresponding to the rest of the visible portion is higher than the optimal strength, the pulse width of the optical beam B corresponding to the visible portion is larger than the conventional one, and the pulse width of the optical beam B corresponding to the rest of the visible portion is smaller than the conventional one, it is possible to form the visible portion more clearly than visual in contrast with the rest of the visible portion.

Further, because respective conditions are set by irradiating the optical beam B before actually recording the recording information Sr, it is possible to set optimal conditions respectively to the optical disk DK where the recording information Sr is actually recorded.

### (II) Second Embodiment

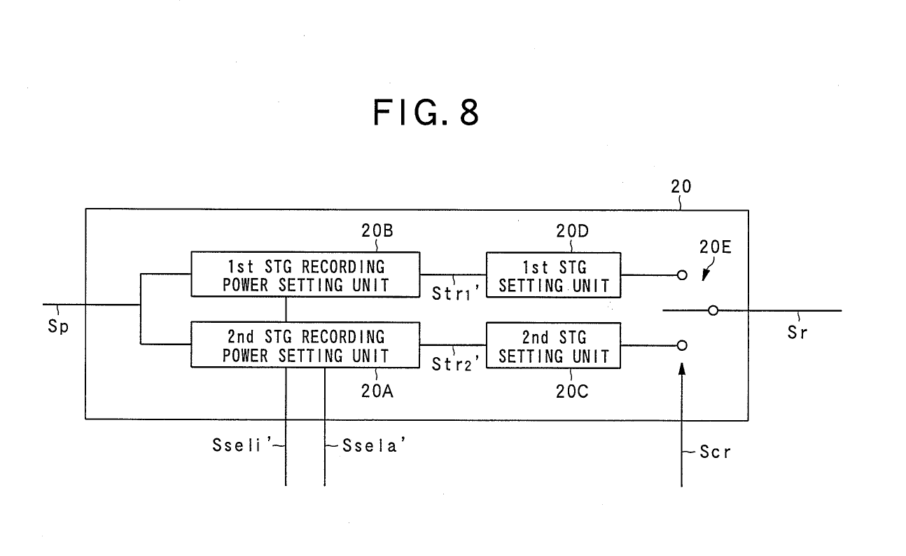

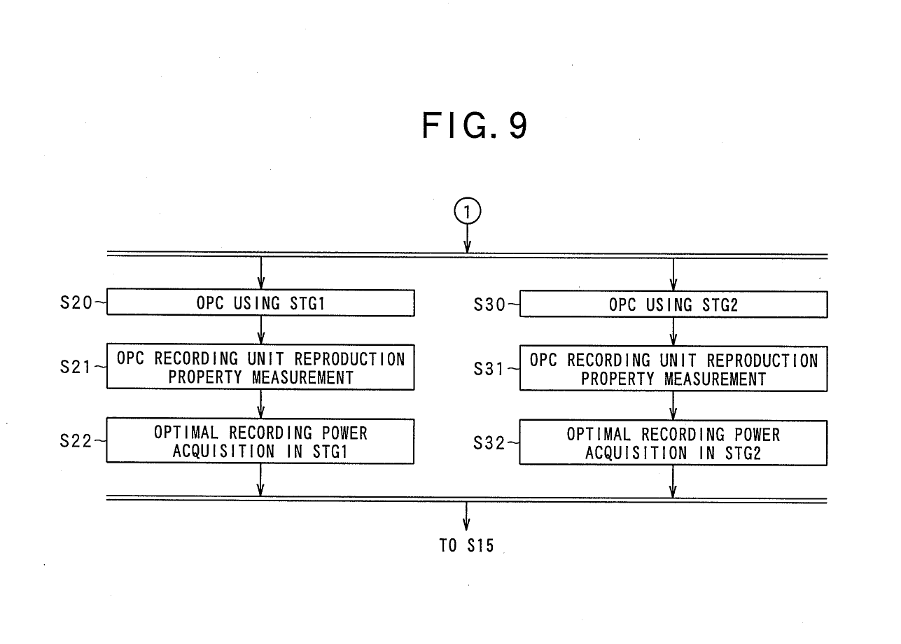

Next, a second embodiment, being another embodiment, related to the present invention will be described with reference to FIGS. 8 and 9. Here, FIG. 8 is a block diagram showing a schematic configuration of a recording condition control unit in an information recording device related to the second embodiment. FIG. 9 is a flowchart showing an OPC operation related to the second embodiment in the information recording device.

Further, because configuration of the portion other than the portion indicated in FIG. 8 in the information recording device related to the second embodiment is similar to the configuration of the information recording device 100 related to the first embodiment, detail explanation is omitted. Further, in the recording process related to the second embodiment, with respect to the portion other than process shown in FIG. 9 (the portion shown in FIG. 3 in the recording process related to the first embodiment and a portion of Steps S15 to S19 shown in FIG. 4), the similar processes are carried out to the processes related to the first embodiment, detail explanation is omitted.

In the above-mentioned embodiment, in the OPC operation (Refer to Steps S10 to S14 in FIG. 4) related to the first embodiment, first the maximum recording power and the minimum recording power are determined (Refer to Step S13 in FIG. 4) and subsequently the pulse width is respectively determined (Refer to Step S14 in FIG. 4). However, in the second embodiment described below, first a pulse width for forming a visible portion and a pulse width for forming a rest of the portion are preset separately, a recording power corresponding to respective pulse width is determined based on a relationship with an optical disk DK where the respective pulse width and the recording information Sr are actually recorded.

In other words, as shown in FIG. 8, a recording condition control unit 20 related to the second embodiment is configured by a first strategy setting unit 20D and a second strategy setting unit 20C respectively memorizing the preset pulse width, a first strategy recording power setting unit 20B, a second strategy recording power setting unit 20A, and a switch 20E.

In this configuration, the recording power of the optical beam B indicated by the first strategy selection information Sseli′ outputted from the recording power selection unit 12 is memorized in the first strategy recording power setting unit 20B.

Further, the recording power of the optical beam B indicated by the second strategy selection information Ssela′ outputted from the recording power selection unit 12 is memorized in the second strategy recording power setting unit 20A.

On the other hand, in the similar manner to the switch 13E related to the first embodiment, an output destination of the recording information Sr is shifted based on the recording condition control signal Scr outputted from the control signal generation unit 10, and it is outputted to any one of the first strategy setting unit 20D and the second strategy setting unit 20C.

When the recording information Sr is outputted to the first strategy setting unit 20D through the switch 20E, the first strategy setting unit 20D generates a strategy signal Str1′ having a pulse wave shape for driving the output unit 2 to cope with the recording information Sr. Here, a pulse width of the strategy signal Str1′ is set so as to correspond to a pulse width of the driving signal Sp previously memorized in the first strategy setting unit 20D.

Accordingly, the first strategy recording power setting unit 20B changes an amplitude in the strategy signal Str1′ outputted from the first strategy setting unit 20D to an amplitude corresponding to the recording power memorized in the first strategy recording power setting unit 20B at that time (i.e. an optimal recording power for the pulse width previously memorized in the first strategy recording power setting unit 20B), and the driving signal Sp having an amplitude corresponding to the recording power indicated by the first strategy selection information Sseli′ is generated and outputted to the output unit 2.

On the other hand, when the recording information Sr is outputted to the second strategy setting unit 20C through the switch 20E, the second strategy setting unit 20C generates a strategy signal Str2′ having a pulse wave shape for driving the output unit 2 to cope with the recording information Sr. Here, a pulse width of the strategy signal Str2′ is set so as to correspond to a pulse width previously memorized in the second strategy setting unit 20C.

Accordingly, the second strategy recording power setting unit 20A changes an amplitude in the strategy signal Str2′ outputted from the second strategy setting unit 20C to an amplitude corresponding to the recording power memorized in the second strategy recording power setting unit 20A (i.e. an optimal recording power for a pulse width previously memorized in the second strategy recording power setting unit 20C), and the driving signal Sp having an amplitude corresponding to the recording power indicated by the second strategy selection information Ssela′ is generated and outputted to the output unit 2.

Next, an OPC operation related to the second embodiment is described with reference to FIG. 9.

As shown in FIG. 9, in the OPC operation related to the second embodiment, processes respectively setting the optimal recording power corresponding to the pulse width are carried out in parallel.

In other words, when processes of Steps S1 to S8 in the recording processes related to the first embodiment (Refer to FIG. 3) are finished, the OPC operation similar to the conventional one and confirmation of the reproduction property are carried out by using the driving signal Sp having a pulse width (a pulse width for forming visible portion or the rest portion) previously memorized in the first strategy setting unit 20D (Steps S20 and S21). The recording power at the time of best reproduction property is set as a recording power optimal to the pulse width previously memorized in the first strategy setting unit 20D (Step S22), and at the same time, the conventional OPC operation and confirmation of the reproduction property are carried out by using the driving signal Sp having the pulse width (a pulse width for forming the opposite portion of visible portion or the rest portion) previously memorized in the second strategy setting unit 20C (Steps S30 and S31). The recording power at the time of best reproduction property is set as a recording power optimal to the pulse width previously memorized in the second strategy setting unit 20C (Step S32), and subsequently the procedure goes to the processes of Step S15 onward (Refer to FIG. 4) related to the first embodiment.

Subsequently, the recording process similar to the recording process related to the first embodiment is carried out, and recording information Sr recording process including forming visible portion is carried out.

The recording process in the information recording device related to the second embodiment thus explained also achieves the effect similar to the recording process in the information recording device 100 related to the first embodiment.

### (III) Modified Embodiment

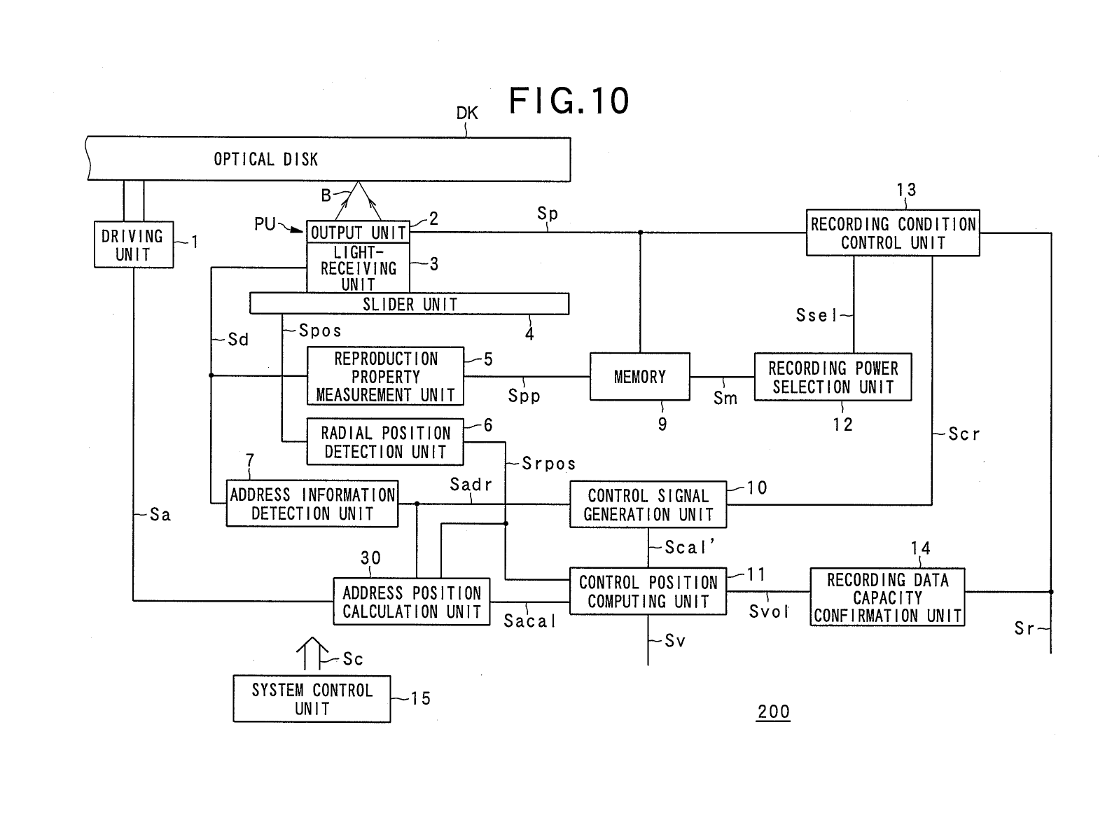

Next, a modified embodiment related to the present invention will be described with reference to FIG. 10. Here, FIG. 10 is a block diagram showing a schematic configuration of an information recording device related to the modified embodiment. With respect to the construction elements similar to the information recording device 100 related to the first embodiment, similar reference numerals are put and detail explanation is omitted.

In the above-mentioned embodiments, the position on the optical disk DK corresponding to the timing of shifting the recording power of the optical beam B and the pulse width corresponding thereto is judged in the control signal generation unit 10 by using angle information Sang from the angle information generation unit 8. However in the modified embodiment described below, the position is judged by using address information previously recorded on the optical disk DK (i.e. address information indicative of a recording position on the information recording surface of the optical disk DK).

In other words, an information recording device 200 related to the modified embodiment is provided with an address position calculation unit 30 instead of the angle information generation unit 8 in the information recording device 100 related to the first embodiment as shown in FIG. 10.

In this configuration, the address position calculation unit 30 obtains a position of preaddress on the optical disk DK (angle from a radial position and a reference) based on preaddress information Sadr outputted from an address information detection unit 7, radial position information Srpos outputted from a radial position detection unit 6, and rotation angle information Sa outputted from the driving unit 1, and outputs it to a control position computing unit 11 as address position information Sacal.

Accordingly, the control position computing unit 11 specifies the region on the optical disk DK where the visible information is formed as address information on the optical disk DK, based on display image information Sv being information such as an image to be recorded together with recording information Sr that are recorded on the optical disk DK as visible information, the confirmation information Svol, and the address position information Sacal, and at the same time, generates the control address information Scal′ indicative of address on the optical disk DK for shifting the recording power and the pulse width of the optical beam B at the time of forming visible information, and outputs it to the control signal generation unit 10.

The control signal generation unit 10 always recognizes the irradiation position of the optical beam B on the optical disk DK. Accordingly, the control signal generation unit 10 generates recording condition control signal Scr indicative of timing for changing an amplitude and a pulse wave shape of the driving signal Sp based on the control address information Scal′ outputted from the control position computing unit 11 and thus recognized irradiation address of the optical beam B, and outputs it to the recording condition control unit 13.

Because the recording process, other than the above-mentioned processes, related to the modified embodiment are similar to the recording process, for example, in the information recording device 100 related to the first embodiment, detail explanation is omitted.

The recording process in the information recording device 200 related to the modified embodiment thus described above also can achieve the effect similar to the embodiments described above.

Here, programs corresponding to flowcharts shown in FIGS. 3 and 4 or 9 are recorded in information recording medium such as a flexible disk and a hard disk, or acquired and recorded through internet or the like, and these are read out and carried out by the general-purpose computer so that the computer can be utilized as the control signal generation unit 10 or the like related to the respective embodiments.

1. An information recording device that forms a visible portion visible from outside on a recording medium by using a recording pit supporting recording information optically recorded on the recording medium comprising:
an output device for irradiating an optical beam for forming the recording pit on the recording medium based on a driving signal;
a driving device for generating the driving signal; and
a control device for controlling the driving device to generate the driving signal, while shifting a visible irradiation condition that indicates strength of the optical beam and a wave shape of the driving signal when forming on the recording medium the visible recording pit being the recording pit to be formed in the visible portion and an ordinal irradiation condition indicative of the strength of the optical beam and the wave shape of the driving signal when forming the recording pit other than the visible recording pit on the recording medium being an ordinal irradiation condition different from the visible irradiation condition on the strength of the optical beam and the wave shape of the driving signal, based on visible portion information indicative of at least any one of position and size of the visible portion on the recording medium,
wherein, the recording information is supported by the recording pit due to the fact that the size of the recording pit changes based on content of the recording information,
the wave shape is a pulse wave shape, and
the pulse wave shape as the visible irradiation condition and the pulse wave shape as the ordinal irradiation condition are respectively a pulse wave shape determined based on maximum recording power and a pulse wave shape determined based on minimum recording power when the recording pit in at least the minimum size is formed on the recording medium.

2. The information recording device according to claim 1,
wherein the control device controls to shift generation of the driving signal applied with the visible irradiation condition and generation of the driving signal applied with the ordinal irradiation condition during the period when the recording information is recorded on the recording medium and the recording pit is not formed.

3. The information recording device according to claim 1,
wherein pulse width is different between the pulse wave shape as the visible irradiation condition and the pulse wave shape as the ordinary irradiation condition in correspondence with a difference between the strength as the visible irradiation condition and the strength as the ordinal irradiation condition.

4. (canceled)

5. The information recording device according to claim 1,
wherein the strength as the visible irradiation condition is higher than an optimal strength for forming the recording pit, and
the strength as the ordinary irradiation condition is lower than the optimal strength.

6. The information recording device according to claim 1,
wherein the strength as the visible irradiation condition is lower than the optimal strength for forming the recording pit, and
the strength as the ordinary irradiation condition is higher than the optimal strength.

7. The information recording device according to claim 3,
wherein the strength as the visible irradiation condition is higher than the strength as the ordinary irradiation condition, and
the pulse width of the pulse wave shape as the visible irradiation condition is smaller than the pulse width of the pulse wave shape as the ordinary irradiation condition.

8. The information recording device according to claim 3,
wherein the strength as the visible irradiation condition is lower than the strength as the ordinary irradiation condition, and
the pulse width of the pulse wave shape as the visible irradiation condition is larger than the pulse width of the pulse wave shape as the ordinal irradiation condition.

9. The information recording device according to claim 1, further comprising:
a setting device for separately setting the visible irradiation condition and the ordinary irradiation condition by irradiating the optical beam on the recording medium before recording the recording information on the recording medium.

10. An information recording program that causes a computer included in an information recording device to function as a control device according to claim 1, the information recording device forming a visible portion visible from the outside on a recording medium by using a recording pit supporting recording information optically recorded on the recording medium, comprising:
an output device for irradiating an optical beam for forming the recording pit on the recording medium based on a driving signal; and
a driving device for generating the driving signal.
